(19) United States
(12) Patent Application Publication
(10) Pub. No.: US 2004/0014603 A1
(43) Pub. Date: Jan. 22, 2004

(54) Aqueous agents containing pesticides

(76) Inventors: Horst-Werner Wollenweber, Duesseldorf (DE); Andreas Rathjens, Dusseldorf (DE); Hans-Georg Mainx, Leichlingen (DE)

Correspondence Address: COGNIS CORPORATION, PATENT DEPARTMENT, 300 BROOKSIDE AVENUE, AMBLER, PA, 19002, US

(21) Appl. No.: 10/415,117

(22) PCT Filed: Oct. 16, 2001
(86) PCT No.: PCT/EP01/11911

(30) Foreign Application Priority Data
Oct. 24, 2000 (DE) 100 52 588.1

(51) Int. Cl. A01N 57/00; A01N 25/04; A01N 25/16

(52) U.S. Cl. 504/128; 504/365

(57) ABSTRACT

A water-based composition having increased pesticidal effect is comprised of (a) glyphosate and (b) cationically derivatized sorbitol and/or cationically derivatized cyclodextrin.

### FIELD OF THE INVENTION

This invention relates generally to agrochemicals and, more particularly, to special water-based compositions containing pesticides in combination with additives which enhance the effect of the pesticides.

### PRIOR ART

Aqueous solutions or emulsions of pesticides are commonly used in agriculture to protect valuable crops against attack by pests. By selecting suitable additional components (adjuvants), these formulations can be adapted to meet practical requirements. On account of the potential threat to the environment posed by the use of pesticides, there is a general demand to enhance their effect through suitable forms of application or by suitable formulation. In addition, the corresponding compositions are required to remain stable over long periods at different temperatures. Accordingly, one problem addressed by the invention was to provide plant protection compositions containing solid and liquid, water-soluble and oil-soluble pesticides which would be distinguished by greater storage stability and activity (adjuvant effect) and which, in particular, could readily be diluted with water. In addition and preferably, the effect of the pesticidal agents would be increased so as the enable the concentrations used to be reduced. A known pesticide is glyphosate which has already been the subject of numerous formulation proposals, cf. WO 97/36493 which proposes water-based glyphosate-containing compositions to which polyethoxylated alcohols are added as adjuvants to improve the phytotoxicity of the active ingredient. It is known from WO 00/38523 that glyphosate can be used in combination with betaines and optionally ethoxylated surfactants as wetters to enhance the herbicidal effect. It is known from applicants' DE 199 14 295 that cationically derivatized alkyl glucosides (APGs) are suitable, together with pesticides, for forming stable emulsions. However, there is no mention of any penetration-increasing effect.

It has now been found that a combination of glyphosate with selected compounds from the group of derivatized sugars also leads to a distinct improvement in the pesticidal effect and that, at the same time, stable water-based compositions can be prepared.

### DESCRIPTION OF THE INVENTION

The present invention relates to water-based compositions containing at least

(a) glyphosate and

(b) cationically derivatized sugars.

It has been found that compositions which contain glyphosate together with cationically derivatized sugars and optionally adjuvants satisfy the requirement profile in excellent fashion. In particular, the derivatized sugars show improved penetration and retention of the glyphosate. The preparations are distinguished from conventional emulsions by improved stability in storage and greater activity. In addition, they can readily be diluted with water and also enable other pesticides to be subsequently incorporated.

Pesticides

The compositions according to the invention contain glyphosate as their key constituent. Glyphosate is N-(phosphonomethyl)glycine, C₃H₈NO₅P, MW 169.07, melting point 200° C., LD₅₀ (rat, oral) 4320 mg/kg (WHO), a nonselective systemic leaf herbicide which is used in the form of its isopropylamine salt for the total and semitotal control of unwanted grasses and weeds, including deep-rooting several-year-old species, among all agricultural crops, in orchards and vineyards. The structure of glyphosate is as follows:

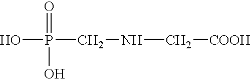

In the context of the present invention, glyphosate is understood to include all the glyphosate derivatives known to the expert, i.e. preferably the mono- or diethanolamine salts of glyphosate. Sodium and potassium are also suitable cations. However, the isopropylamine salt of glyphosate is particularly preferred. In addition, mixtures of these compounds may also be used for the purposes of the invention.

The pesticides which may be used as an additional component (s) are preferably oil-soluble substances. Fungicides, herbicides, insecticides or mixtures thereof may be used. Typical examples of suitable fungicides are azoxystrobin, benalaxyl, carbendazim, chlorothalonil, cupfer, cymoxanil, cyproconazol, diphenoconazol, dinocap, epoxyconazol, fluazinam, flusilazol, flutriafol, folpel, fosetyl alumnium, kresoxim methyl, hexaconazol, mancozeb, metalaxyl, metconazol, myclobutanil, ofurace, phentinhydroxide, prochloraz, pyremethanil, soufre, tebucanazol and tetraconazol and mixtures thereof. Suitable herbicides include alachlor, acloniphen, acetochlor, amidosulfuron, aminotriazol, atrazin, bentazon, biphenox, bromoxyl octanoate, bromoxynil, clethodim, chlodinafop-propargyl, chloridazon, chlorsulfuron, chlortoluron, clomazon, cycloxydim, desmedipham, dicamba, dicyclofop-methyl, diurea, difluphenicanil, dimithenamid, ethofumesat, fluazifop, fluazifop-p-butyl, fluorochloridon, fluroxypyr, glufosinat, glyphosate, galoxyfop-R, ioxynil octanoate, isoproturon, isoxaben, metamitron, metazachlor, metolachlor, metsulfuron-methyl, nicosulfuron, notflurazon, oryzalin, oxadiazon, oxyfluorphen, paraquat, pendimethalin, phenmedipham, phenoxyprop-p-ethyl, propaquizafop, prosulfocarb, quizalofop, sulcotrion, sulphosat, terbutylazin, triasulfuron, trichlorpyr, triflualin and triflusulforon-methyl wich may be used in individually or in admixture withone another. Finally, suitable insecticides include biphenthrin, carbofuran, carbosulfan, chlorpyriphos-methyl, chlorpyriphos-ethyl, β-cyfluthrin, λ-cyhalothrin, cyhexatin, cypermethrin, dicofol, endosulfan, τ-fluvalinat, α-methrin, δ-methrin, phenbutatin, pyrimicarb, terbuphos and tebuphenpyrad and mixtures thereof. Other suitable pesticides can be found, for example in the Index Phytosanitaire 1998, 34th Edition (published by Association de Coordination Technique Agricole, Paris).

Cationically Modified Sugars

As indicated at the beginning, the cationic sugar derivatives (B) are obtained in known manner by derivatization of sugar molecules. Sugars in the context of the invention are generally understood to be monomeric, oligomeric and polymeric carbohydrates. Both the carbohydrates as such and preferably their reduced forms and the alkylated and/or alkoxylated derivatives of such sugars are suitable educts for the production of the cationic derivatives used in accordance with the invention. Within these groups, the reduced sugars which are not further derivatized are preferably used.

Particularly preferred sugars for the production of component (b) are those selected from compounds with the formula [G-(OR″)ₙ]ₖ where G is a cyclic or aliphatic sugar unit containing 3 to 6 carbon atoms, n is a number of 3 to 6, R″ is hydrogen or an alkyl group containing 1 to 22 carbon atoms or a group (C₂H₄O)ₘ, where m is a number of 1 to 30, and k is a number of 1 to 150. Suitable sugars are, for example, the hexopyranoses idose, gulose, talose, altrose, allose, galactose, mannose, glucose and reduced derivatives thereof. In addition, non-reduced sucrose may also be used for the production of components (b) according to the invention. Besides the monomeric sugars, oligomeric and polymeric saccharides may also be used for the production of the modified sugars used in accordance with the invention. Examples of such saccharides include the cyclodextrins and also inulin, a polymeric fructose.

Preferred starting materials are sugars selected from the group of cyclodextrins and sorbitol. The cyclodextrins are known substances which are formed, for example, during the degradation of starch by Bacillus macerans or Bacillus circulans under the effect of cyclodextrin glycosyl transferase. The cyclodextrins consist of 6, 7 or 8 alpha-1,4-linked glucose units (alpha-, beta- or gamma-cyclodextrins). Further particulars can be found in Römpps Lexikon Chemie—Electronic Version 2.0, Stuttgart/New York; Georg Thieme Verlag 1999. Sorbitol is also a known compound.

Sorbitol is also a suitable basis for the preparation of cationic sugar derivatives according to the invention. Sorbitol has the empirical formula C₆H₁₄O₆, molecular weight 182.17. The D-sorbitol known as D-glucitol under IUPAC/IUB is a hexahydric alcohol (sugar alcohol) belonging to the hexitols. Further particulars can be found under the key word “sorbitol” in Römpp Lexikon Chemie—Version 2.0, Stuttgart/New York: Georg Thieme Verlag 1999.

Production is preferably carried out by reaction of the primary hydroxyl group of the above-mentioned glycosides with halogen compounds or epoxides containing a quaternary ammonium group. Such compounds correspond to formula (I):

X—R′—NR₃⁺X⁻ (I)

where R^{′} is a difunctional alkyl group containing 2 to 8 carbon atoms which may even be branched and/or functionalized. X represents a halogen atom, preferably chlorine. R′ is preferably a group —C₃H₆— or C₃H₅OH—. In the latter case, the hydroxyl group is attached to the middle carbon atom of the chain. The substituents R independently of one another are C₁₋₂₄ alkyl groups. Compounds of formula (I) in which at least one substituent R is a C₈₋₁₈ alkyl group are particularly preferred. Other particularly preferred compounds of formula (I) are those in which one substituent R is a C₈₋₁₈ alkyl group and the other two substituents R are alkyl groups containing fewer than 8 carbon atoms, preferably a C₁₋₄ alkyl group and more preferably a methyl group.

Typical examples of suitable halogen compounds are the 3-chloro-and 3-bromo-2-hydroxypropyl trialkyl ammonium chlorides which are marketed by Degussa AG under the name of “Quab®”. The reaction between sugar and halogen compound is carried out in the presence of strong bases such as, for example, sodium hydroxide, potassium hydroxide, sodium methylate or potassium tert.butylate which may be used both in solid form and as a concentrated aqueous solution. The reaction is typically carried out at relatively mild temperatures of 30 to 50° C. and over reaction times of 12 to 68 hours. The reactants sugar and halogen compound are normally used in substantially equimolar quantities or with Quab in excess, a pH of 8 to 11 being adjusted with the base. “In excess” preferably means a molar ratio of monomeric sugar to Quab of 1:2. In the case of the cyclodextrins, the Quab is used in a 10-to 20-fold molar excess.

Cationically derivatized sugars (b) based on sorbitol or cyclodextrins corresponding to formula (II) are preferably used. In the case of cyclodextrins, products corresponding to formula (II) are obtained:

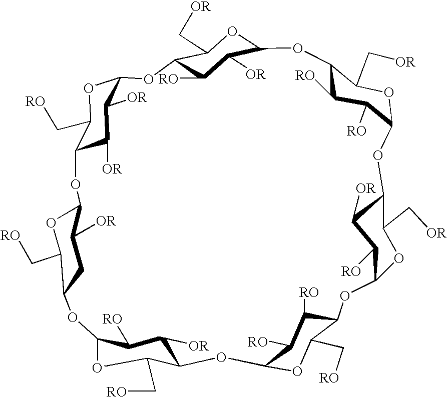

where R is a hydrogen atom and/or a group corresponding to the following formula:

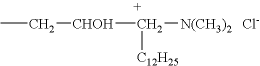

In the case of sorbitol as sugar source, compounds corresponding to formula (III), for example, are obtained:

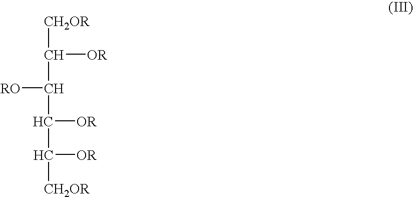

In formula (Ill), R has the same meaning as in formula (II). Such derivatives can be obtained by reaction of cyclodextrins or sorbitol with Quab® 342 (N,N-dimethyl-N-dodecylchloride) as described above. Individual hydroxyl groups only or all the hydroxyl groups are substituted according to the reaction conditions. In the case of sorbitol, the primary hydroxyl group is preferably substituted. However, this also results in the formation of isomers substituted at the secondary hydroxyl groups. In the reaction of cyclodextrins with Quab 342, the reaction is followed by an additional purification step, preferably by dialysis.

Adjuvants

In a preferred embodiment of the invention, the compositions may contain adjuvants (c) as optional constituents in addition to the cationic sugar derivatives (b). Suitable adjuvants are, for example, nonionic surfactants from at least one of the following groups:

(1) products of the addition of 2 to 120 mol ethylene oxide and/or 0 to 75 mol propylene oxide onto linear fatty alcohols containing 8 to 22 carbon atoms, fatty amines, onto fatty acids containing 8 to 22 carbon atoms, onto alkylphenols containing 8 to 15 carbon atoms in the alkyl group and C₆₋₂₂ fatty amines;

(2) C_{12/18} fatty acid monoesters, diesters and triesters of products of the addition of 1 to 120 mol ethylene oxide onto glycerol and technical oligoglycerols;

(3) glycerol monoesters and diesters and sorbitan monoesters and diesters of saturated and unsaturated fatty acids containing 6 to 22 carbon atoms and ethylene oxide adducts thereof;

(4) alkyl mono- and oligoglycosides containing 8 to 22 carbon atoms in the alkyl group and ethoxylated analogs thereof;

(5) products of the addition of 15 to 60 mol ethylene oxide onto castor oil and/or hydrogenated castor oil;

(6) polyol esters and, in particular, polyglycerol esters such as, for example, polyglycerol polyricinoleate or polyglycerol poly-12-hydroxy-stearate. Mixtures of compounds from several of these classes are also suitable;

(7) products of the addition of 2 to 15 mol ethylene oxide onto castor oil and/or hydrogenated castor oil;

(8) partial esters based on linear, branched, unsaturated or saturated C_{6/22} fatty acids, ricinoleic acid and 12-hydroxystearic acid and glycerol, polyglycerol, pentaerythritol, dipentaerythritol, sugar alcohols (for example sorbitol), alkyl glucosides (for example methyl glucoside, butyl glucoside, lauryl glucoside) and polyglucosides (for example cellulose);

(9) trialkyl phosphates and mono-, di- and/or tri-PEG-alkyl phosphates and salts thereof;

(10) wool wax alcohols;

(11) polysiloxane/polyalkyl polyether copolymers and corresponding derivatives;

(12) mixed esters of pentaerythritol, fatty acids, citric acid and fatty alcohol according to DE-PS 1165574 and/or mixed esters of fatty acids containing 6 to 22 carbon atoms, methyl glucose and polyols, preferably glycerol,

(13) polyalkylene glycols and

(14) glycerol carbonate.

The addition products of ethylene oxide and/or propylene oxide onto fatty alcohols, fatty acids, alkylphenols, glycerol monoesters and diesters and sorbitan monoesters and diesters of fatty acids or onto castor oil are known, commercially available products. They are homolog mixtures of which the average degree of alkoxylation corresponds to the ratio between the quantities of ethylene oxide and/or propylene oxide and substrate with which the addition reaction is carried out. C_{12/8} fatty acid monoesters and diesters of addition products of ethylene oxide onto glycerol are known as lipid layer enhancers for cosmetic preparations from DE-PS 20 24 051. C_{8/18} alkyl mono- and oligoglycosides, their production and their use as surfactants are known, for example, from U.S. Pat. No. 3,839,318, U.S. Pat. No. 3,707,535, U.S. Pat. No. 3,547,828, DE-OS 1943689, DE-OS 2036472 and DE-A1 3001064 and EP-A1 0 077 167. They are produced in particular by reaction of glucose or oligosaccharides with primary alcohols containing 8 to 18 C atoms. So far as the glycoside component is concerned, both monoglycosides, in which a cyclic sugar unit is attached to the fatty alcohol by a glycoside linkage, and oligomeric glycosides with a degree of oligomerization of preferably up to about 8 are suitable. The degree of oligomerization is a statistical mean value on which a homolog distribution typical of such technical products is based.

Solvents

It is advisable to use nonpolar solvents, particularly when pesticides that are solid at room temperature are to be incorporated in the emulsions. Suitable nonpolar solvents as a further optional component (d) are, for example, mineral oils, aromatic alkyl compounds and the hydrocarbons marketed, for example, under the name of Solvesso® by Exxon, fatty acid lower alkyl esters such as, for example, the C_{1-4,} i.e. the methyl, ethyl, propyl and/or butyl esters of caproic acid, caprylic acid, 2-ethylhexanoic acid, capric acid, lauric acid, isotridecanoic acid; myristic acid, palmitic acid, palmitoleic acid, stearic acid, isostearic acid, oleic acid, elaidic acid, petroselic acid, linoleic acid, linoleic acid, elaeostearic acid, arachic acid, galoeic acid, behenic acid and erucic acid and technical mixtures thereof. Also suitable are vegetable triglycerides such as, for example, coconut oil, palm oil, palm kernel oil, sunflower oil, olive oil and the like. Another suitable solvent is polyethylene glycol, preferably with molecular weights in the range from 90 to 600 and more particularly in the range from 120 to 250.

In a preferred embodiment, the compositions according to the invention contain

(a) 0.01 to 60, preferably 0.5 to 55% by weight pesticides,

(b) 0.05 to 45, preferably 1 to 30% by weight cationically derivatized sugars,

(c) 0 to 10, preferably 1 to 3% by weight adjuvants and

(d) 0 to 40, preferably 5 to 30% by weight solvents,

with the proviso that the quantities shown add up to 100% by weight with water and optionally other typical auxiliaries and additives. The average water content of the compositions is 10 to 90% by weight and preferably 30 to 60% by weight. The application solution actually used contains component (a) in quantities of 0.01 to 5% by weight, preferably 0.1 to 2.5% by weight and more particularly 0.1 to 1.5% by weight. Component (b) is present in the application solution in quantities of 0.05 to 5% by weight, preferably 0.5 to 3% by weight and more particularly 0.5 to 2.0% by weight (all figures based on the aqueous application solution as a whole).

However, the compositions according to the invention may also be marketed as concentrates, for example containing 10 to 90% by weight (a), 10 to 90% by weight (b) and 0 to 10% by weight (c) or 0 to 40% by weight (d), the actual in-use concentration being adjusted before application by dilution. The water content of such concentrates is between 1 and 30% by weight.

The present invention also relates to the use of the cationically derivatized sugars (b) as an auxiliary in glyphosate-containing water-based pesticide formulations in which they may be present in quantities of 0.05 to 45% by weight and preferably in quantities of 1 to 30% by weight, based on the composition. It has been found that the combination of glyphosate with the cationically modified sugars (b) surprisingly strengthens the effect of the pesticides. In particular, penetration of the active ingredients (a) into the plant surface is improved. This means that the concentrations in which the pesticides (a) are used can be reduced so that the adverse effects of using such pesticides on the environment can also be reduced. Retention of the pesticide on the leaf surface is also improved. Accordingly, the present invention also relates to the use of cationically modified sugars (b) for enhancing the effect of glyphosate. Finally, the present invention relates to a process for controlling unwanted plant growth in which the water-based compositions described in the foregoing are applied to the unwanted plants. The glyphosate (active substance) is typically applied in quantities of 50 to 600 g per hectare and preferably in quantities of 100 to 350 g per hectare. The compositions are applied by any of the methods known to the expert, but especially by spraying.

### EXAMPLES

A Preparation of Cationically Derivatized Sugars

A.1 Preparation of Cationically Derivatized Sorbitol Materials:

| | | | |
|---|---|---|---|
| 1. | 160 g | sodium hydroxide, 50% | = 2 mol |
| 2. | 100 g | dist. water | |
| 3. | 182 g | sorbitol (Karion Pulver p300) | = 1 mol |
| 4. | 1710 g | Quab 342 40% (Degussa) | = 2 mol |
| 5. | ca. 40 ml | hydrochloric acid, 37% | |
| 6. | 2000 ml | methanol | |

Method:

1. and 2. were introduced first and stirred with 3., mixture heated to 60° C.; 4. added dropwise in 1 h; stirred for 4 h at 60° C. The mixture was then neutralized by addition of 5. and freeze-dried. The crude product was then taken up in 6.; undissolved solids were removed and the filtrate was concentrated at ca. 40° C. and freeze-dried. 880 g of product were obtained.

A.2 Preparation Cationically Derivatized Cyclodextrin Materials:

| | | | |
|---|---|---|---|
| 1. | 112.0 g | sodium hydroxide, 50% | = 1.4 mol |
| 2. | 120.0 g | dist. water | |
| 3. | 113.5 g | β-cyclodextrin | = 0.1 mol |
| 4. | 1197 g | Quab 342 40% (Degussa) | = 1.4 mol |
| 5. | 10 g | hydrochloric acid, 37% | |

Method:

1., 2. and 3. were introduced first and dissolved while stirring at ca. 40° C.; mixture heated to 60° C.; 4. added dropwise over 3 h. The mixture was then stirred for 24 h at 60° C. The mixture was neutralized by addition of 5. and the crude product was then dialyzed in an MWCO 1000 dialysis tube. The dialysis residue was concentrated in a rotary evaporator and then freeze-dried. Yield: 77 g.

B Performance Tests

The penetration-increasing effect for glyphosate of the claimed compounds was evaluated by the following tests:

The application solutions were prepared with distilled water one day before the treatment. The glyphosate spray solutions were prepared both with unmarked glyphosate (glyphosate content 97.5%, Dr. Ehrenstorfer GmbH, Augsburg, Germany) and with (¹⁴C)-glyphosate ([N-phosphono-(¹⁴C)-methyl)glycine], specific activity 2.04 GBq/mmol, radiochemical purity 98.1%, Amersham Pharmacia Biotech Europe GmbH, Freiburg, Germany). Marked active substance was added to the unmarked active substance and the whole was dissolved in water so that the application solution had a glyphosate concentration of 0.7% and a radioactivity of 1.85 kBq/μl.

The surfactants added are shown in Table 1.

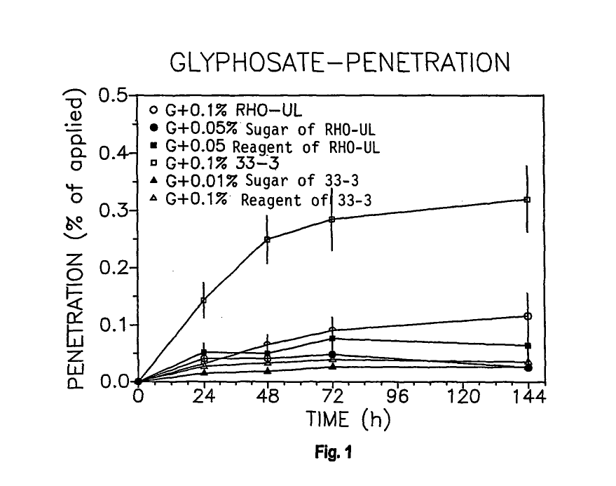

TABLE 1

| Code | Description | Abbreviation in FIG. 1 |
|---|---|---|
| C1 | Cationically derivatized APG according | RHO-UL |
| | to DE 19914295 (cocoalkyl oligoglycoside | |
| | reacted with Quab ® 151) | |
| C2 | Non-derivatized APG (cocoalkyl | Sugar of RHO-UL |
| | oligoglycoside) | |
| C3 | Quab ® | Reagent of RHO-UL |
| C4 | Sorbitol | Sugar of 33-3 |
| C5 | Quab ® 342 | Reagent of 33-3 |
| E1 | Sorbitol cationically derivatized with | |
| | Quab ® 342 | |

The surfactant concentration in the application solutions was 0.1%. An application solution containing Roundup Ultra (36% glyphosate, Monsanto Düsseldorf, Germany), to which (¹⁴C) has been added, was used as reference.

Measurement of Cuticular Penetration

The cuticular penetration of glyphosate was determined using a finite dose diffusion system after the method of OHKOUCHI, BUKOVAC and NOGA (1998). To this end, the isolated cuticula was clamped between two plastic rings, checked for impermeability and then positioned onto the finite dose diffusion cell with the morphological cuticula upper surface directed towards the ambient air. A volume of 3.0 ml of deionized water was used as the receiver solution in the diffusion cell. In the receiver cell, a magnetic stirrer prevented the occurrence of boundary layer effects.

Three individual 1 μl drops of the active-ingredient-containing solutions were applied to the physiological upper side of the cuticula by a microliter syringe (see chap. 1.1.1) after addition of the surfactants to be tested. The concentration of glyphosate in the receiver solution in direct contact with the inside of the cuticula was determined after 24, 48, 72 and 144 h and after 6, 24 and 48h. At these times, 500 μl was taken from the receiver solution by Eppendorf pipette and 10 ml of scintillation cocktail were added. The cells were then topped up again with distilled water.

The radioactivity in liquid samples was measured by a liquid scintillation spectrometer (Canberra Packard LSC 2500TR) with quench correction through sample- and scintillation-specific calibration series. In the test, 10 ml Instant Scintillator Gel (Canberra Packard) were added to each liquid sample, followed by measurement in the LSC. For background correction, the scintillation cocktail was added to the corresponding inactivated solvent. The radioactivity values of a measurement series could then be automatically corrected by this value. All samples were counted for up to 15 minutes depending on the radioactivity level. The results were calculated in percent of the applied radioactivity.

Results

The results of the penetration tests are shown in FIG. 1. It is clear that glyphosate in combination with the cationically derivatized sorbitan according to the invention has unexpectedly better penetration than without any adjuvant or in the presence of individual sugars. Surprisingly, the active substance also shows improved penetration by comparison with the teaching of DE 19914295. The abbreviation G in FIG. 1 stands for glyphosate.

1. Water-based compositions containing at least
(a) glyphosate and
(b) cationically derivatized sugars.

2. Compositions as claimed in claim 1, characterized in that component (b) is obtained by reacting sugars with compounds corresponding to formula (I):
X—R′—NR₃^{+X}⁻ (I)
where R′ is a difunctional alkyl group containing 2 to 8 carbon atoms which may even be branched or functionalized and the substituents R independently of one another are C₁₋₂₄ alkyl groups and X is a halogen atom.

3. Compositions as claimed in claim 2, characterized in that at least one of the substituents R in formula (I) is a C₈₋₁₈ alkyl group.

4. Composition as claimed in claims 1 to 3, characterized in that the sugars forming component (b) are selected from compounds with the formula [G-(OR″)ₙ]ₖ where G is a cyclic or aliphatic sugar unit containing 3 to 6 carbon atoms, n is a number of 3 to 6, R″ is hydrogen or an alkyl group containing 1 to 18 carbon atoms or a group and/or (C3H60)m (C₂H₄O)ₘ, where m is a number of 1 to 30, and k is a number of 1 to 150.

5. Compositions as claimed in claims 1 to 4, characterized in that the sugars for the production of component (b) are selected from reduced sugars.

6. Compositions as claimed in claims 1 to 5, characterized in that component (b) is obtained by reaction of cyclodextrins or sorbitol or sorbitol derivatives with 3-chloro-2-hydroxypropyl-N,N-dimethyl-N-dodecyl chloride.

7. Compositions as claimed in at least one of claims 1 to 6, characterized in that they additionally contain adjuvants as an optional component (c).

8. Compositions as claimed in claim 7, characterized in that they contain as component (c) adjuvants selected from the group consisting of products of the addition of 2 to 120 mol ethylene oxide and/or 0 to 75 mol propylene oxide onto linear fatty alcohols containing 8 to 22 carbon atoms, fatty amines, onto fatty acids containing 8 to 22 carbon atoms and onto alkylphenols containing 8 to 15 carbon atoms in the alkyl group; C₆₋₂₂ fatty amines; C_{12/18} fatty acid monoesters, diesters and triesters of products of the addition of 1 to 120 mol ethylene oxide onto glycerol or oligoglycerols; glycerol monoesters and diesters and sorbitan monoesters and diesters of saturated and unsaturated fatty acids containing 6 to 22 carbon atoms and ethylene oxide adducts thereof; alkyl mono- and oligoglycosides containing 8 to 22 carbon atoms in the alkyl group and ethoxylated analogs thereof; products of the addition of 15 to 60 mol ethylene oxide onto castor oil and/or hydrogenated castor oil; polyol esters; products of the addition of 2 to 15 mol ethylene oxide onto castor oil and/or hydrogenated castor oil; partial esters based on linear, branched, unsaturated or saturated C_{6/22} fatty acids, ricinoleic acid and 12-hydroxystearic acid and glycerol, polyglycerol, pentaerythritol, dipentaerythritol, sugar alcohols; alkyl glucosides; trialkyl phosphates and mono-, di- and/or tri-PEG-alkyl phosphates; wool wax alcohols; polysiloxane/polyalkyl polyether copolymers and corresponding derivatives; mixed esters of pentaerythritol, fatty acids, citric acid and fatty alcohol and/or mixed esters of fatty acids containing 6 to 22 carbon atoms, methyl glucose and polyols; polyalkylene glycols and glycerol carbonate.

9. Compositions as claimed in at least one of claims 1 to 8, characterized in that they additionally contain solvents as an optional component (d).

10. Compositions as claimed in claim 9, characterized in that they contain mineral oil, aromatic alkyl compounds, fatty acid lower alkyl esters and/or vegetable triglycerides as component (d).

11. Compositions as claimed in any of claims 1 to 10, characterized in that they contain
(a) 0.01 to 60% by weight pesticides,
(b) 0.05 to 45% by weight cationically derivatized sugars,
(c) 0 to 10% by weight adjuvants and
(d) 0 to 40% by weight solvents,
with the proviso that the quantities shown add up to 100% by weight with water and optionally other typical auxiliaries and additives.

12. The use of the cationically derivatized sugars (b) according to claim 1 as performance enhancers in water-based glyphosate-containing compositions.

13. A process for controlling unwanted plant growth, characterized in that the water-based composition claimed in claim 1 is applied to the plants.
